(19) United States
(12) Patent Application Publication
(10) Pub. No.: US 2011/0292677 A1
(43) Pub. Date: Dec. 1, 2011

(54) HIGHLY INERT FLUID-HANDLING OPTICAL SYSTEMS

(76) Inventor: Valentine John ROSSITER, Waterford (IE)

(21) Appl. No.: 13/100,627

(22) Filed: May 4, 2011

(30) Foreign Application Priority Data
May 5, 2010 (GB) 1007530.7

(51) Int. Cl. F21V 29/00

(52) U.S. Cl. 362/580

(57) ABSTRACT

A fluid-handling optical system such as a light-pipe assembly of a GC/FTIR apparatus includes a light pipe 10, preferably of gold, surrounded by a body 9. The body is of a material where the linear thermal expansion coefficient differs very little from that of the pipe 10. Thus they can sealingly abut a non-resilient end abutment, e.g. involving a gold disc 4.

### BACKGROUND OF THE INVENTION

The present invention relates to highly inert fluid-handling optical systems, generally comprising light pipe assemblies.

Previously described constructions of light-pipes consisting essentially of solid gold tubing housed within another material are satisfactory, provided relatively soft polymeric materials are used as “window cushions” at the ends of the light-pipe where they generally abut “windows” such as infrared transmitting windows. The soft material can absorb any slight differences in the coefficient of linear thermal expansion between the gold and the material of the structure housing the gold tube which forms the light-pipe. However, the presence of the soft polymeric cushions places limitations on the temperature range of operation, and also on the nature of samples that can be handled.

U.S. Pat. No. 4,822,166 discloses methods for the analysis of gas samples, particularly in the area of interfacing Gas Chromatography (GC) and Fourier Transform Infrared Spectroscopy (FTIR). However, the methods are limited in upper temperature by the use of soft polymeric sealing materials such as PTFE.

U.S. Pat. No. 5,223,716 discloses how systems for the optical analysis of fluids at high temperatures can be extended to the condition where high temperature is combined with high pressure. It is still desired to develop more highly inert systems.

Materials such as pure gold are regarded as offering exceptional levels of chemical inertness for a wide variety of materials under various conditions. However, these materials are generally very expensive and may not provide the necessary mechanical properties to provide suitable mechanical connections for threaded parts necessary to form high pressure seals.

Traditionally, gold has been used to form the inner surfaces of light-pipes for applications such as combined Gas Chromatography (GC) and Fourier Transform Infrared Spectroscopy (FTIR). For such interfacing techniques (GC/FTIR), I have previously taught the advantages of short light-pipes (U.S. Pat. No. 4,822,166). I have further taught that the use of solid gold internal surfaces formed in pure gold tubing is advantageous over the more conventional use of gold coatings which are typically applied to the inner surfaces of glass tubing. (Rossiter V, Dykeman J, Berube G, “GC/FTIR for the Spectroscopist”, Spectroscopy, 1 (12), 39-41 (1986); Rossiter V, Dykeman J, Baudais F, Berube G, “An Integrated GC/FTIR System”, American Laboratory, (1987)). Such solid gold tubing can be incorporated into housings made from other materials, such as aluminum or stainless steel. The use of such housings reduces the amount of solid gold required and also provides connections for the gas stream to be formed in relatively hard materials suited to forming such connections by conventional means. Such light-pipe structures use soft “window cushions” between the ends of the light-pipes and the infrared transmitting window materials, typically potassium bromide or other infrared transmitting material. However, the upper temperature limit of such devices is then determined by the upper temperature limit of the polymeric material, typically PTFE. Because the window cushion is exposed to the gas stream, the upper temperature is preferentially significantly below the maximum working temperature of the polymer as any decomposition or off-gassing products from the polymer will enter the gas stream and can lead to erroneous analytical data or can contaminate the inner surfaces of the light-pipe also leading to impaired analytical data. Ideally an inert, non-polymeric window cushion would be selected for the system, for example gold could be used instead of the polymeric window cushion but this cannot be done with conventional structures because of the effects of differential thermal expansion in the overall light-pipe structure which cannot be accommodated by the releatively rigid gold. The following invention shows how this can be achieved.

### SUMMARY OF THE INVENTION

The present invention provides a more highly inert system with increased upper temperature limits for such applications and for other applications.

The present invention shows how the desirable properties of materials like gold can be utilized in a variety of fluid systems, including those configured for the optical examination of fluid samples.

The invention provides a light-pipe assembly comprising:

a tube of inert material (e.g. gold), the tube having an outer surface (typically cylindrical) and terminating at one end with a planar end face;

a body closely embracing the outer surface of the tube, said body terminating at one end with a face portion which is coplanar with said planar end face of the tube; and

a window element adjacent the planar end face of the tube and the coplanar face portion and optionally a disc of rigid inert material interposed between the window element and the planar end face of the tube and the coplanar face portion of the body to serve as a window cushion.

Preferably the body is formed of a material whose coefficient of linear thermal expansion is similar to that of the tube. Thus it may have a coefficient that differs from that of the tube by no more than 1% over a useful working range (e.g.)0-300°. For example, if the tube is of pure gold (whose coefficient is 14.7×10⁻⁶ over the range)0-300°, the body may be formed from a nickel alloy such as Incoloy™ 925 (coefficient: 14.75×10⁻⁶ at)0-300°. This is an age-hardenable nickel-iron-chromium alloy (chemical composition: nickel, 42%; iron, 32%; chromium, 21%; molybdenum, 3%; copper, 2.2%; titanium, 2.1%; aluminium, 0.3%, and carbon, 0.02%). Thus for a typical short (60 mm) light-pipe, the difference between the materials at one end is ˜0.0005 mm on going from ambient to 320°. This is well within the manufacturing tolerances, and so insignificant.

By selecting a material which closely matches the relatively low thermal coefficient of linear expansion of gold as the structural material, the use of soft polymeric cushions becomes unnecessary, and the entire assembly is capable of working to significantly higher temperatures and providing a greater degree of chemical inertness for the light-pipe.

The window element may be urged against the disc by a compressed resilient element such as a high temperature polymeric O-ring seal, a soft graphited material, or other suitable high temperature material. This is isolated from the interior of the gold tube and so should not be a source of contaminants. For still greater reassurance, and higher temperature operation, a gold O-ring may be employed. This or certain other materials may require the use of a secondary chamber. For example, as disclosed in U.S. Pat. No. 5,223,716, there may be a second window element contained in an external secondary gas pressurized enclosure where the gas pressure acts on the first window element.

The light-pipe assembly may have a similar arrangement at each end, involving a gold disc and a window element abutting co-planar surface portions of the gold tube and the body.

The disc may be of the same material as the tube, e.g. pure gold. The disc generally has an aperture. This can provide an optical pathway between the interior of the tube and the window. The aperture can also be formed so as to provide a gas flow path linking the interior of the tube and a conduit defined within the body and within the wall of the tube.

### BRIEF DESCRIPTION OF DRAWINGS

FIG. 1 is a longitudinal cross-section of part of a light-pipe assembly comprising a first embodiment of the invention.

FIGS. 2-4 are views similar to FIG. 1 but showing modified embodiments.

### DESCRIPTION OF EMBODIMENTS

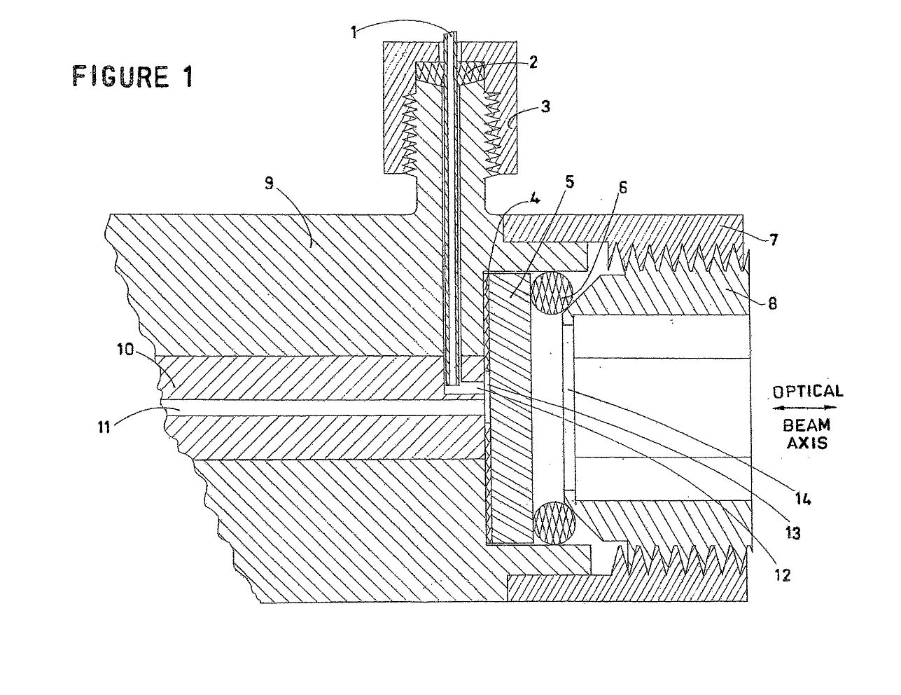

A first embodiment of the invention will now be described by way of example with reference to FIG. 1. This shows a section through one end region of a light-pipe assembly.

The invention is here illustrated with reference to one typical application, that of a device for GC/FTIR interfacing. Those familiar with the art will readily appreciate the extension of the invention to other and more general applications in the analysis of fluids. FIG. 1 shows a part cross-sectional view of one end of a device capable of fulfilling the objectives of the invention. The other end of the device is a mirror image of the end view shown in FIG. 1. The device consists of a solid, pure gold tube 10 with a smooth internal bore 11 through which a beam of light can pass and through which a gas flow can pass while being exposed to the light beam for compositional analysis of the flowing gas stream. Further gas passages are formed in each end as illustrated by 12 which is connected to 11 via a cut-out 13 in the solid gold disc 4 which serves as a “window cushion” for optical window 5. Window cushion 4 and optical window 5 are compressed by a hollow screw 8 with a clear aperture 14, so compressing o-ring 6 to form a gas tight-seal. Screw 8 travels in local housing 7 which is fixed to body 9 by conventional means. The body 9 is a close fit to gold tube 10 and also serves to provide gas entry to optical cavity 11 via tube 1 which is sealed by conventional seal 2 to a gas port formed in 9 using conventional compression fitting 3. Tube 1 within body 9 can be quartz tube (or other material) to provide inertness in the gas passage way, where tube 1 terminates within the entry 12 formed in gold tube 10. In such a way, the gas flow passes entirely within highly inert materials and into optical cavity 11. The material of construction for body 9 is chosen to closely match the linear coefficient of thermal expansion of the material used for 10, which is typically solid gold. Suitable materials for the construction of body 9 can be found in the range of currently available Nickel alloys. This actual example employed Incoloy 925. (INCOLOY is a trademark.) In this way, window cushion 4 is not subjected to distorting differential stresses caused by temperature variation and so maintains one flat surface contacting the plane end faces of tube 10 and body 9 and the other flat surface contacting window 5. The dimensions within the gas passageways can be selected to provide minimum turbulence and minimum volume to preserve the integrity of the time varying composition of the gas. The volume of optical cavity 11 is selected for analysis purposes depending on gas flow rates, the nature of the time dependence of the varying gas composition and the optics of the FTIR spectrometer. The device described can be heated to the desired operating temperature for the gas analysis by conventional means and mounted in a suitable manner by conventional means in an FTIR spectrometer or in the external optical bench of such a spectrometer. Gas connections to the GC are heated in a conventional manner. If o-ring seal 6 is manufactured from a polymeric material with a high temperature rating, the device can be used fully to this maximum temperature as off-gassing or minor decomposition products of o-ring 6 do not enter the gas stream or contaminate any of the gas pathways or contaminate the surfaces of the light-pipe formed by optical cavity 11; this is because the structural integrity of window cushion 4 is maintained over a wide temperature range so that it remains in contact with the end faces of body 9 and tube 10 as well as the face of optical window 5. In this way, temperatures of at least 320 degC. can be achieved.

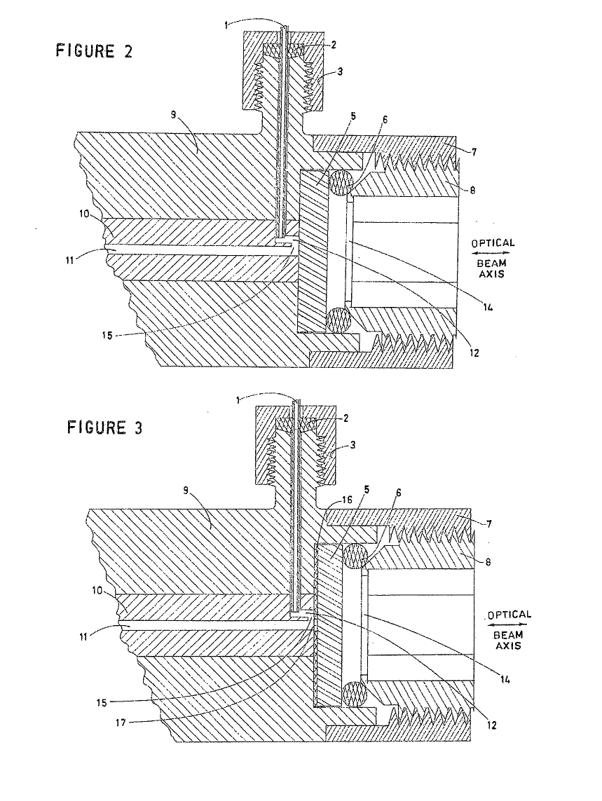

FIG. 2 shows a first variant in which there is no gold window cushion (item 4 in FIG. 1). There is a recess 15 in the end face of the tube 10 to provide a connection for gas to pass through the tube 1 and passage 12, and reach the light pipe cavity 11.

FIG. 3 shows a second variant. This retains a gold window cushion 16 with a central opening 17, and also has a recess 15 in the end face of the tube 10.

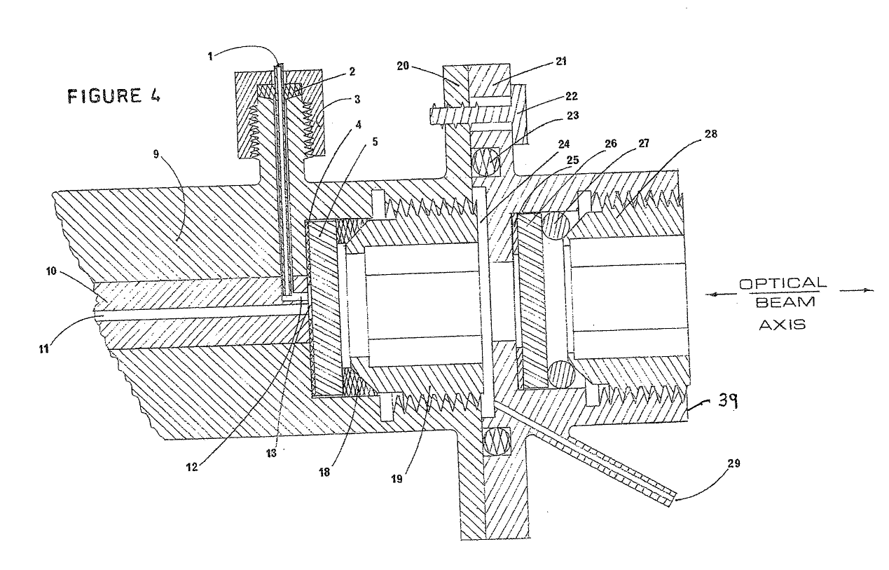

Even higher operating temperatures and pressures can be achieved while maintaining the contamination-free and inertness advantages, by replacing o-ring 6 with a high temperature seal such as a gold o-ring or a seal of graphited material, and using secondary chambers as taught in U.S. Pat. No. 5,223,716. Such an embodiment is shown in FIG. 4. An assembly substantially as shown in FIG. 1 includes a quartz capillary tube 1 for gas feed; a standard soft seal 2 as used in gas chromatography; a compression nut 3; an apertured gold disc 4 (with aperture 13); an optical window 5; a body 9; a gold tube 10 with an optical cavity 11; and a gas pathway 12. In this case, the body 9 extends beyond the optical window 5, to a flange 20.

On the side of the window 5 remote from the light pipe 10, it is contacted by a high temperature seal 18, such as a seal formed of compressive graphite material, such as GRAFOIL (trademark of UCAR Carbon Technology Co). It is enclosed in a secondary chamber for containing a secondary inert gas volume 24. The secondary chamber has a second optical window 26 in its end wall aligned with the light pipe cavity 11 and the opening 13 in the disc 4. The seal 18 is urged against the first window 5 by a compressive hollow screw 19, analogous to the screw 8 in the first embodiment. The secondary chamber is generally pressurised with gas, via an inlet 29, to lessen the pressure differential across the window 5, as taught in U.S. Pat. No. 5,223,716.

The secondary chamber is formed partly by the extension of the body 9 and partly by a rear body 39. The bodies 9, 39 have respective flanges 20, 21 which abut and are secured by bolts (illustrated by bolt 22). The flange 21 of the rear body 39 has an annular cavity having an O-ring seal 23 for sealing between the flanges 20, 21. The extension of the main body 9 has an internal thread which engages a hollow screw 19 which compresses the high temperature seal 18. The flange 21 of the rear body 39 extends radially into the secondary chamber, providing a seat for the second optical window 26, which engages it via a window cushion 25. This can be formed from a polymeric material since it is not subjected to high temperatures. The rear body 39 has an internal thread. This is engaged by a hollow screw 28 which compresses an O-ring seal 27 against the second optical window 26.

Preferred embodiments of the invention can offer one or more of the following advantages:

a. A method for providing a highly inert fluid passageway for the optical analysis of fluids of varying composition as they flow through an optical cavity and allowing the compositional analysis of such fluid streams by conventional optical means.

b. A method according to (a), where a highly inert material can be used as an optical cavity as part of the structure and be advantageously housed within another material of closely matched coefficient of linear thermal expansion.

c. A method according to (a) and/or (b) where a highly inert material can be used as a window cushion at the end of such optical cavities while contacting an optical window and where the surface of the window cushion remains in contact with the optical window and the optical cavity end surface while the temperature of these components is varied.

d. A method according to (a), (b) and/or (c) where polymeric o-rings or other materials subject to high temperature decomposition or other high temperature limitation, can be used to provide a gas tight seal at high temperature without contamination of the fluid streams or contamination of the optical cavity.

e. A method according to (d) where such o-rings can be used to their maximum operating temperature for extended time periods without causing contamination of the fluid streams or contamination of the optical cavity.

f. A method according to (a), (b) and/or (c) where the upper temperature and pressure can be further extended by replacing the polymeric o-rings with other materials and incorporating a secondary chamber. This can be operated at a lower temperature than the primary device, as previously taught in U.S. Pat. No. 5,223,716.

The present invention has been described with reference to preferred embodiments. The skilled reader will appreciate that these are merely illustrative examples and that modifications and variations are possible. It is intended to cover all such modifications and variations within the scope of the appended claims.

1. A light-pipe assembly comprising:
a tube of inert material, the tube having an outer surface and terminating at one end with a planar end face;
a body closely embracing the outer surface of the tube, said body terminating at one end with a face portion which is coplanar with said planar end face of the tube; and
a window element adjacent the planar end face of the tube and the coplanar face portion; and wherein the body is formed of a material whose coefficient of linear thermal expansion at any temperature within an operating range of at least 0-300° differs from that of the tube by no more than about 1%.

2. A light-pipe assembly according to claim 1 wherein said tube is of gold.

3. A light-pipe assembly according to claim 1 wherein said body is formed from a nickel alloy.

4. A light-pipe assembly according to claim 1 including a disc of rigid inert material interposed between the window element and the planar end face of the tube and the coplanar face portion of the body to serve as a window cushion.

5. A light-pipe assembly according to claim 4 wherein said disc is of gold.

6. A light-pipe assembly according to claim 1 further including a resilient element which contacts the window element on the side remote from the tube and urges it towards the tube.

7. A light-pipe assembly according to claim 1 further including a high-temperature seal element which contacts the window element on the side remote from the tube and urges it towards the tube.

8. A light-pipe assembly according to claim 7 wherein the high-temperature seal element is a disc of rigid insert material.

9. A light-pipe assembly according to claim 8 wherein said disc of rigid inert material is of gold.

10. A light-pipe assembly according to claim 7 wherein said high-temperature seal element is formed of graphited material.

11. A light-pipe assembly according to claim 1 which includes an enclosure at the side of the window element remote from the tube for containing a pressurised gas atmosphere to enable operation at higher temperature and/or pressure.
